(19) United States
(12) Patent Application Publication
(10) Pub. No.: US 2007/0198854 A1
(43) Pub. Date: Aug. 23, 2007

(54) Data protection apparatus, data protection method, and program product therefor

(75) Inventor: Koji Suzuki, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/507,539

(22) Filed: Aug. 22, 2006

(30) Foreign Application Priority Data
Feb. 17, 2006 (JP) 2006-040668

(51) Int. Cl. H04L 9/00; G06F 12/14; H04L 9/32; G06F 11/30

(52) U.S. Cl. 713/189; 380/44; 713/155

(57) ABSTRACT

A data protection apparatus includes a determination portion that determines an encryption key used for encrypting edited data in consideration of a total value of each piece of data of one or more pieces of data, when the edited data that includes the one or more pieces of data is created on the basis of the one or more pieces of data, and an encryption portion that encrypts the edited data on the basis of the encryption key determined by the determination portion.

### BACKGROUND

1. Technical Field

This invention relates to a data protection apparatus, a data protection method, and a program for utilizing electronic contents securely by encrypting the electronic contents.

2. Related Art

When there are multiple different protection targets in a piece of content, in general, a method of encrypting the respective protection targets by using individual keys is utilized. For example, when contents are encrypted based on XML Encryption specifying standards in encrypting XML (Extensible Markup Language) documents, individual public encryption keys are generally assigned to respective protection targets, unless a user specially designates an encryption key common to the respective protection targets. In general, to encrypt protection targets in contents, firstly, the protection targets are encrypted by using individual common keys assigned to the respective protection targets, and then the common keys are encrypted by using public keys assigned to the respective protection targets. Then, the encrypted common keys are attached to an XML document. When a user views the contents, the encrypted common keys are decrypted by using previously obtained secret keys assigned to the respective protection targets, and then the respective encrypted protection targets are decrypted by using such common keys.

### SUMMARY

An aspect of the present invention provides a data protection apparatus including: a determination portion that determines an encryption key used for encrypting edited data in consideration of a total value of each piece of data of one or more pieces of data, when the edited data that includes the one or more pieces of data is created on the basis of the one or more pieces of data; and an encryption portion that encrypts the edited data on the basis of the encryption key determined by the determination portion.

### BRIEF DESCRIPTION OF THE DRAWINGS

Embodiments of the present invention will be described in detail based on the following figures, wherein:

FIG. 1 is a diagram showing a relation among a person, servers and the like that are related to distributing and viewing contents according to a first exemplary embodiment of the present invention;

FIG. 2 is a diagram showing a structure of a customer information management system according to the first exemplary embodiment of the present invention;

FIG. 3 is a flowchart showing a procedure to be conducted by a user that uses a content;

FIG. 4 shows a procedure of the content management server that encrypts the confidential file and transmits the encrypted confidential file and secret keys to the user;

FIG. 5 is a diagram showing a relation among a person, servers and the like that are related to distributing and viewing contents according to a second exemplary embodiment of the present invention;

FIG. 6 is a diagram showing a structure of a system according to the second exemplary embodiment of the present invention;

FIG. 7 is a flowchart showing a procedure which should be conducted by a user who utilizes a confidential file in the second embodiment; and

FIG. 8 shows a procedure conducted by a customer information management server, which encrypts the confidential file and transmits the encrypted confidential file and a secret key to the user according to a second exemplary embodiment of the present invention.

### DETAILED DESCRIPTION

A description will now be given of embodiments of the invention.

### First Exemplary Embodiment

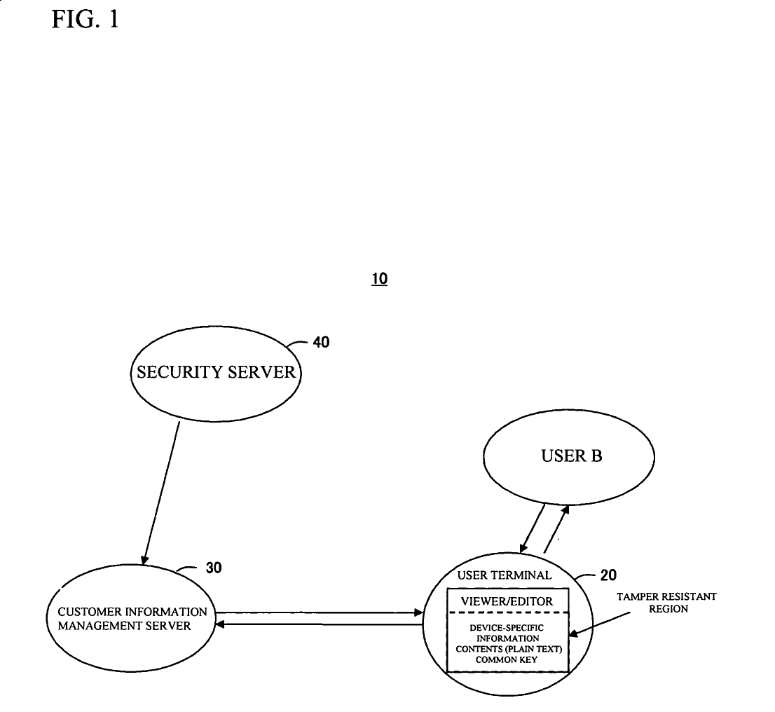

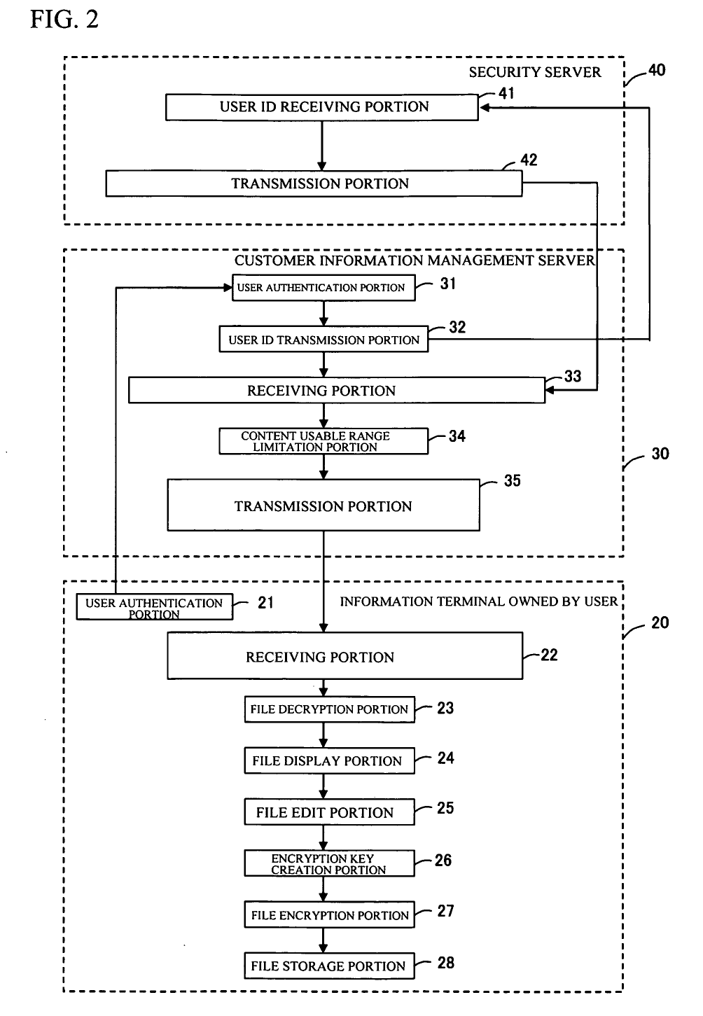

A description will now be given of a customer information management system according to a first exemplary embodiment of the invention with reference to FIG. 1 through FIG. 4. FIG. 1 is a diagram showing a relation among a person, servers and the like that are related to distribution and view of contents. FIG. 2 is a diagram showing a structure of the customer information management system in the present exemplary embodiment. As shown in FIG. 1, a customer information management system 10 has an information terminal owned by a user (hereinafter referred to as “user terminal”) 20 as a data protection apparatus, a customer information management server 30, and a security server 40.

In the present exemplary embodiment, a description will be given of a case where a user B is a sales person of company A, and downloads one or more confidential files describing customer information to the user terminal 20 used by the user B through a corporate LAN (Local Area Network). The user B then merges the multiple confidential files in the course of edit to create one edited confidential file. The user B views the above-described edited confidential file by using the user terminal 20 outside the company for business operation.

The security server 40 retains user qualification information necessary for determining a user's usable range, security guideline information describing information such as an estimated unit price of customer records used for determining a contents value, and security policy information prepared by a company. The security server 40 has, as shown in FIG. 2, a user ID receiving portion 41 and a transmission portion 42.

The customer information management server 30 specifies a target range of contents used by a user between the customer information management server 30 and the user. The customer information management server 30 has functions of protecting only information in the target range and distributing the protected information to the user. The above-described one or more confidential files are stored in a disk in the customer information management server 30. If necessary, an appropriately authenticated user can download the confidential files and secret keys assigned to the protection targets in the confidential files. Multiple confidential files prepared by company members belonging to the company A are stored in the customer information management server 30. Each confidential file is partly or wholly designated as a protection target. Encrypted regions are encrypted by using individual public keys. That is, individual encryption keys are assigned to the respective confidential files.

The customer information management server 30 has, as shown in FIG. 2, a user authentication portion 31, a user ID transmission portion 32, a receiving portion 33, a content usable range limitation portion 34, and a transmission portion 35. The user authentication portion 31 authenticates a user who accesses the customer information management server 30. The user ID transmission portion 32 transmits a user ID of the certified user to the security server 40. The receiving portion 33 acquires user qualification information and security guideline information from the security server 40 by using a communication network such as a LAN. The content usable range limitation portion 34 limits contents utilization range on the basis of the user qualification information and the number of customer records. The transmission portion 35 transmits encrypted confidential files, secret keys, and security guideline information.

The user terminal 20 has a user authentication portion 21, a receiving portion 22, a file decryption portion 23, a file display portion 24, a file edit portion 25, an encryption key creation portion 26 serving as a determination portion, a file encryption portion 27, and a file storage portion 28. The user terminal 20 is composed of a personal computer, for example.

The user authentication portion 21 accesses the customer information management server 30 and certifies to the customer information management server 30 that the user is authenticated to view and edit confidential files. For proving qualification of utilizing contents, for example, an electronic certificate, a smart card, an IC card or the like can be utilized. The receiving portion 22 receives encrypted confidential files, secret keys, and security guideline information from the customer information management server 30. The file decryption portion 23 decrypts the encrypted confidential files to clear texts.

The user terminal 20 is provided with a software tampering resistance function for preventing clear texts, encryption keys and the like from leakage (reference: “Tamper Resistant Technology for Software”, IPSJ Magazine, June 2003). The user terminal 20 is further provided with a viewer/editor with the security assured by the tamper resistant function for software. The user B views or edits the encrypted confidential files by using the viewer/editor. The viewer/editor functions as the file display portion 24 and the file edit portion 25.

When a newly edited confidential file including contents of one or more confidential files is prepared based on the one or more confidential files, the encryption key creation portion 26 determines an encryption key for encrypting the edited confidential file in consideration of a total value of each of the one or more confidential files. Then, when the one or more confidential files are assigned with individual encryption keys, the encryption key creation portion 26 uses, as an encryption key for encrypting the edited confidential file, the encryption key being smaller in number than the encryption keys assigned to the one or more confidential files. Here, the encryption keys being smaller in number include a secret key and a public key of RSA encryption. In the present exemplary embodiment, information on value of the one or more confidential files is used as information on the one or more confidential files. As the information on the one or more confidential files, for example, it is also possible to use a data amount of the one or more confidential files, information on the encryption keys assigned to the one or more confidential files, and the like.

Further, the encryption key creation portion 26 determines protection intensity applied to an edited confidential file depending on a protection period of the edited confidential file, distribution path information of the edited confidential file, information on a device utilizing the edited confidential file, or user profile information on a user utilizing the edited confidential file. Further, the encryption key creation portion 26 designates protection intensity applied to the edited confidential file by using a length of the created encryption key.

Here, the protection period of a confidential file is determined by a security policy of each corporation. Information on the protection period of the confidential file is described in security guideline information. Distribution path information of a confidential file is determined by a user terminal type. The server acquires the distribution path information on the confidential file from the security server 40 on the basis of a device ID. In the case of a mobile terminal, the distribution path of the confidential file is an external network such as a WAN, thus necessitating stronger security. Again, in the case of the mobile terminal, information on a device that uses the confidential file is based on a portable device. Therefore, in view of the risk such as losing the device, stronger security is demanded. The server also acquires user profile information from the security server 40 based on the user ID.

To make assurance of protecting the edited confidential file, the encryption key creation portion 26 determines a key length of an encryption key so that an estimated value of a cost necessary for cracking the encrypted confidential file becomes equal to or more than a total value of one or more confidential files. The encryption key creation portion 26 is realized by a program retained in a tamper resistant region of the viewer/editor.

The file encryption portion 27 encrypts an edited confidential file with the use of encryption keys for the edited confidential file being smaller in number than the encryption keys that encrypt one or more confidential files. The file storage portion 28 retains a file encrypted by the file encryption portion 27.

In the present exemplary embodiment, it is assumed that an electronic ticket method is utilized as a method for realizing protection of contents (reference: Japanese Patent Application Publication No. 10-164051, “User authentication apparatus and method thereof”). In the electronic ticket method assumed here, a user registers information specific to a device owned by the user in the customer information management server 30. The customer information management server 30 issues differential information between the information specific to the device and an encryption key utilized for protecting confidential information, as an electronic ticket to the user. In the electronic ticket method, difficulty in calculation amount such as factorization into prime factors or discrete logarithm is utilized. Thereby, in view of the calculation amount, it is difficult for the user itself and third parties to calculate the information specific to the user device and the information on the encryption key utilized for protecting a confidential file from the above-described difference information. Therefore, the confidential file and secret information attached thereto are practically prevented from leakage.

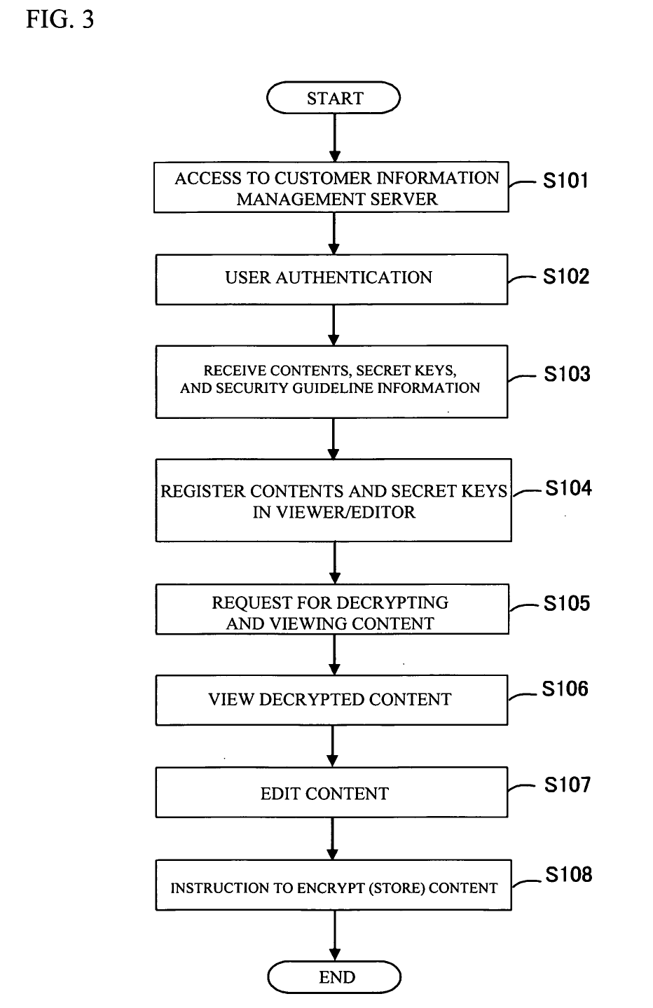

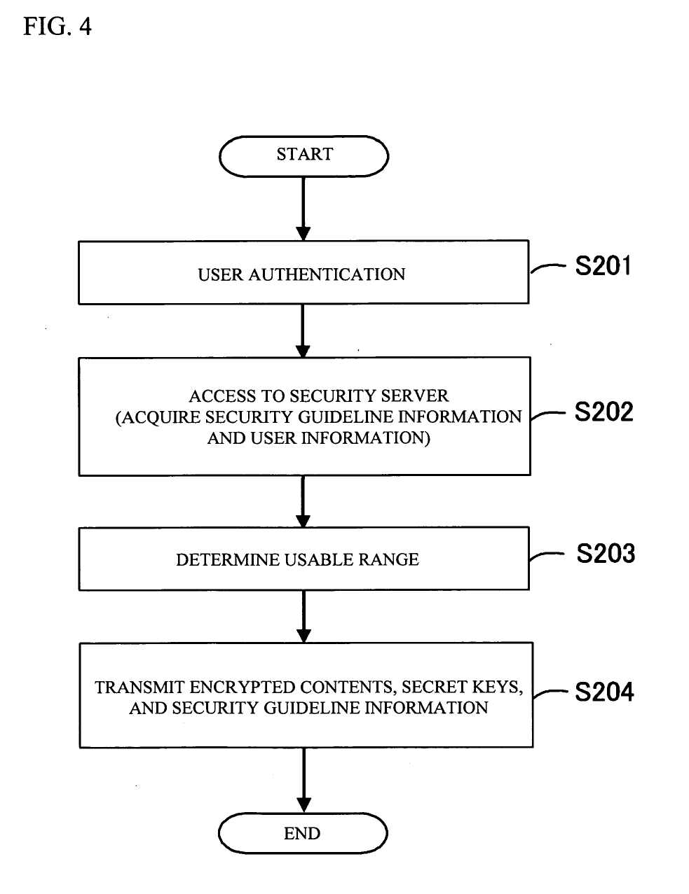

Next, with reference to FIG. 3 and FIG. 4, a description will be given of procedures of a user and the server that are conducted when a confidential file is used. FIG. 3 is a flow chart showing a procedure to be conducted by a user that uses a content. FIG. 4 shows a procedure of the content management server that encrypts the confidential file and transmits the encrypted confidential file and secret keys to the user. Firstly, the user authentication portion 21 of the user terminal 20 accesses the customer information management server 30 to utilize customer information (step S101). Then, the user authentication portion 21 authenticates that the user is authenticated to view and edit the confidential files by using an electronic certificate or the like to the customer information management server 30 (step S102).

When user authentication is completed between the user B and the customer information management server 30 (step S201), the user ID transmission portion 32 of the customer information management server 30 accesses the security server 40. The receiving portion 33 acquires user information and security guideline information including an estimated unit price of a customer record and the like necessary for determining the value of the confidential file (step S202). The content usable range limitation portion 34 determines a range of usable customer information for the user B based on the user qualification information of the user that utilizes the one or more confidential files (step S203). Then, the transmission portion 35 transmits the confidential file, the security guideline information and the like to the user B (step S204).

Here, it is assumed that the user B operates the user terminal 20 and edits three confidential files F1, F2, and F3 to create an edited confidential file F4. It is also assumed that the user B obtains authentication of viewing and editing the confidential files F1 through F3. Customer information for the number of customers M1, M2, and M3 is respectively described in the confidential files F1 through F3. In editing, it is assumed that the user B describes customer information for the number of customers M4=M1+M2+M3 in the edited confidential file F4.

Protection targets describing the customer information which exist in the confidential files F1, F2, and F3 are encrypted by using public keys e1, e2, and e3 respectively. A protection target of the edited confidential file F4 describing the customer information for M4 is encrypted by using a public key e4 described later. Lengths of secret keys corresponding to the public keys e1, e2, e3, and e4 are d1, d2, d3, and d4 respectively. The transmission portion 35 transmits the confidential files F1, F2, and F3, the above-described secret keys, and transmits the security guideline information to the user terminal 20 by a method described later in detail (step S204).

Next, a description will be given of viewing operation of the encrypted confidential files by the user B in detail. As described above, the user B views and edits the encrypted confidential files F1, F2, and F3 by using the viewer/editor protected by the tamper resistant function. Therefore, the user B receives the acquired secret keys corresponding to the public keys e1, e2, and e3, the confidential files F1, F2, and F3, and the security guideline information (step S103), which are then registered in the viewer/editor (step S104). The registration is automatically conducted by a program retained in the tamper resistant region, after the user B designates the confidential files F1, F2, and F3 to be downloaded from the customer information management server 30.

The communication with the customer information management server 30 for downloading is carried out on condition that a safe communication path such as a VPN (Virtual Private Network) is established. Thus, confidential information such as the secret keys is not leaked to the user and third parties. Further, decrypted confidential files F1 through F3 and the secret keys and the common keys to be used for decrypting the confidential file are always protected by the above-described tamper resistant function for software. This prevents the user and third parties from taking such information out of the device.

The viewer/editor decrypts the encrypted common keys attached to the encrypted confidential files F1, F2, and F3 by using the registered secret keys respectively corresponding to the public keys e1, e2, and e3. The file decryption portion 23 decrypts the encrypted confidential files F1, F2, and F3 by using the decrypted common keys. The file display portion 24 displays the user the decrypted confidential files F1, F2, and F3 (steps S105 and S106). All the above-described processing is conducted while all the confidential information is retained in the tamper resistant region included in the viewer/editor by utilizing the tamper resistant function.

Next, a description will be given in detail of editing operation of the confidential files by the user B, after the confidential files F1 to F3 are displayed. The viewer/editor as the file edit portion 25 merges the confidential files F1, F2, and F3, and prepares the edited confidential file F4 according to the instruction of the user B (step S107).

In the security guideline information acquired from the customer information management server 30, F denotes an estimated value of a calculation amount purchasable at 1 yen, V denotes an estimated value per a piece of customer information, and Y denotes a protection year. The encryption key creation portion 26 calculates a value T of the edited confidential file F4, by using both an estimated value V per a piece of customer information specified by the security guideline and a number of customer records M, and determines a key length that matches the value of the edited confidential file F4. For example, as shown in the following Expression 1, the encryption key creation portion 26 multiplies the estimated value V per a piece of customer records by the number of customers M. Thereby, the encryption key creation portion 26 calculates the value T of the edited confidential file F4 describing the customer records corresponding to the number of customers M, determines a key length that matches the calculated value T of the calculated confidential file F4, and prepares a secret key having the key length and the corresponding public key e4. The file encryption portion 27 decrypts a protection target describing the customer information by using the public key (step S108).

T=M×V (Expression 1)

By utilizing the above formula 1, the length d4 of the secret key of RSA encryption used for protection is determined by the following Expression 2.

d4=Min{n|C(n)>T×f(Y)}, C(n)=v(log v), (Expression 2)

v=Min{w|wΨ(x, y)>xy/log y}, f(Y)=F×(2̂(Y/1.5)).

In Expression 2, Ψ(x, y) represents a positive integer equal to or less than x, in which the prime factor thereof does not exceed y. In addition, v is the minimum w that satisfies wΨ(x, y)>xy/log y. For a method of calculating Ψ(x, y), for example, refer to Math. Comp., Vol. 66, pp. 1729-1741, 1997 and Math. Comp., Vol. 73, pp. 1013-1022, electrically published on Jul. 1, 2003, printed in 2004.

The encryption key creation portion 26 creates 160 bit random numbers, which is to be an encryption key of common key encryption utilized for encrypting the protection target of the edited confidential file F4. Then, the file encryption portion 27 encrypts the protection target in the edited confidential file F4 by using the encryption key. Further, the file encryption portion 27 encrypts the common key by using the foregoing public key e4 of RSA cryptosystem, and attaches the encrypted common key to the encrypted edited confidential file F4. The file storage portion 28 retains the secret key of RSA cryptosystem in the tamper resistant region that retains the above-described program.

A description will be hereinafter descried of a procedure in a case where the edited confidential file F4 is viewed by the user B in mobile environment such as the outside of the office. Firstly, the user B starts up the user terminal 20. Subsequently, the user B requests for viewing the edited confidential file F4 to the program in the tamper resistant region retained in the user terminal 20. Then, the program demands the user authentication to the user B. The user B conducts user authentication by utilizing an IC card or the like to certify that the authenticated user is trying to view the edited confidential file F4. By the user authentication, even if the user terminal 20 is stolen, the confidential information is prevented from being leaked. For conducting the user authentication, for example, an electronic certificate, a smart card or the like can be utilized in addition to the IC card.

After the user authentication, the program decrypts the encrypted section in the edited confidential file F4 by using a secret key of RSA cryptosystem retained in the tamper resistant region of the user terminal 20, and displays the edited confidential file F4 on the viewer of the user terminal 20. The user B can view an image of necessary customer information and the like of the edited confidential file F4 displayed on the viewer.

The above-described method will be discussed under the following conditions. That is, the information on the value per a piece of customer information V is set to 15,000 (yen), the number of customer records M4 usable by the user B is set to 10,000 (persons), the protection years Y is set to 15 (years), and the estimated value F of a calculation amount purchasable at 1 yen is 1.00915×10̂12 (bits). Here, the value of F is calculated on the assumption that a retail price of a personal computer of 3.2 GHz is 100,000 yen. (reference: Simson Garfinkel, “PGP: Pretty Good Privacy”, O'Reilly, 1994). Here, when an optimal key length is calculated by the above-described method, the key length is 1,063 bits. A key length utilized in the confidential files F1, F2, and F3 is 2,048 bits. Here, assuming that decryption time of the RSA cryptosystem is in proportion to the number obtained by raising a key length to the third power, decryption of the RSA cryptosystem can be conducted approximately 21 times faster substantially by using the above-described method.

In the above-described exemplary embodiment, the RSA cryptosystem is utilized particularly for protecting the contents. However, when another public key encryption such as ElGamal encryption, Elliptic Curve Cryptography, or NTRU is used, similar effects can be obtained. Further, when setting the number of records in a confidential file allowed for a user to view, an estimated time necessary for cracking the encrypted confidential file by using an assumed device such as a personal computer may be shown to the user as referential information, so that the user may adjust the range setting.

Further, the encryption key creation portion 26 can calculate the value T of the confidential file F4 describing the customer record corresponding to the number of customers M by adding a reduction B yen of brand value associated with discredit caused by customer information leakage, to a result obtained by multiplying the estimated value V per a piece of customer records by the number of customers M as shown in the following Expression 3. Then, the encryption key creation portion 26 can determine a key length corresponding to the calculated value of the confidential file F4.

T=V×M+B (Expression 3)

Further, as calculation expressions for setting the optimal key length d4, the following expressions can be cited.

d4=Min{n|C(n)>T×f(Y)},

C(n)=Exp((1.92+o(1))×((log n)̂(1/3))*((log log n)̂(2/3))),

f(Y)=F×2̂(Y/1.5),

Alternatively, a modified one of the afore-mentioned expressions may be used. In the afore-mentioned expressions, C(n) represents a calculation amount of number field sieve method, which is the most offensive method against the cryptosystem that depends on difficulty of factorization into prime factors such as RSA (reference: A. K. Lenstra, H. W. Lenstra (eds.), “The development of the number field sieve”, Lecture Notes in Mathematics, Vol. 1554, Springer-Verlag, Berlin and Heidelberg, Germany, 1993).

Further, effects similar to the above-described ones are obtainable when a system is structured as follows. In such a structure, a virtually independent network is built by air-gap technique for safely managing customer information. On communication paths in the network, confidential files are not particularly encrypted. However, when the customer information is taken outside the network, the above-described contents protection method is utilized.

### Second Exemplary Embodiment

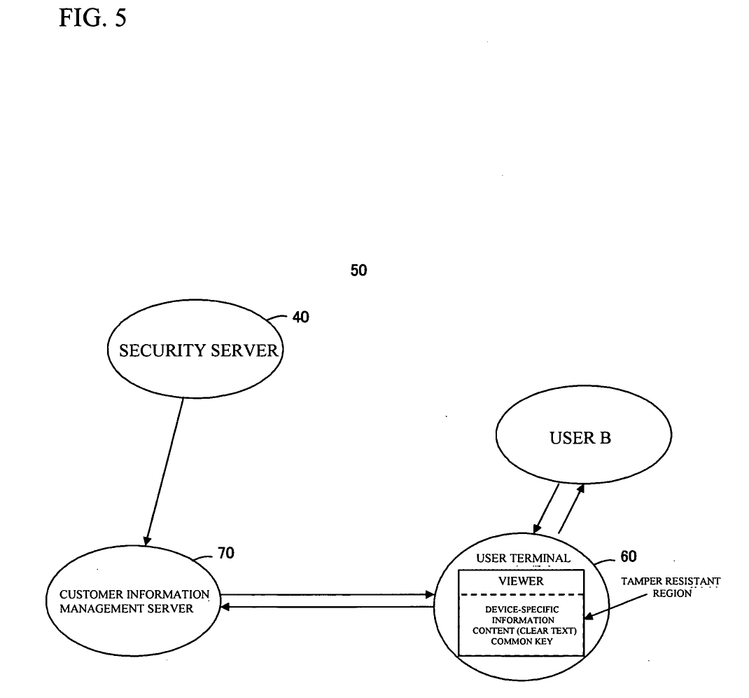

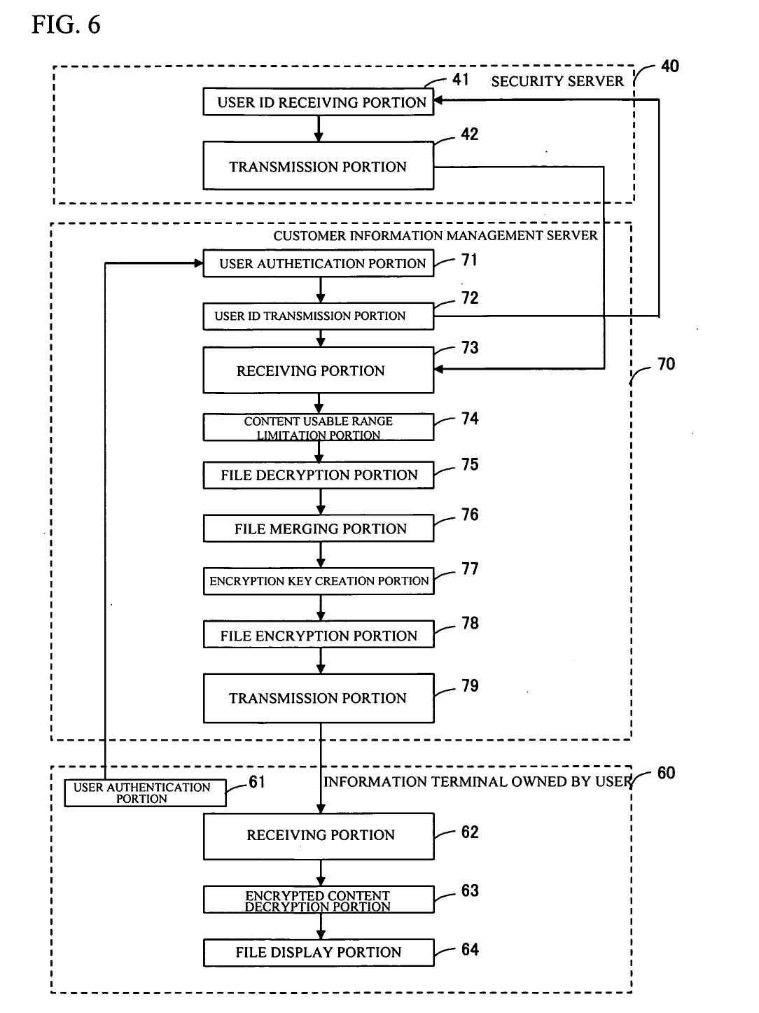

Next, a description will be given of a second exemplary embodiment of the invention. In the second exemplary embodiment, a description will be given of the case where the customer information management server merges the confidential files F1, F2, and F3, creates an encryption key used for encrypting the edited confidential file F4 merged, and encrypts the edited confidential file F4. The user terminal only decrypts and displays the encrypted edited confidential file F4. FIG. 5 is a diagram showing a relation among a person, servers and the like that are related to distributing and viewing contents. FIG. 6 is a diagram showing a structure of a system according to the second exemplary embodiment.

In the second exemplary embodiment, the user B obtains authentication to view the confidential files F1, F2, and F3 as in the first exemplary embodiment. Customer information for the number of customers M1, M2, and M3 is respectively described in the confidential files F1, F2, and F3. A relation between the public keys and the secret keys that are related to the confidential files is similar to that of the first exemplary embodiment. That is, protection targets having the customer information which exist in the confidential files F1, F2, and F3 are encrypted by using the public keys e1, e2, and e3 respectively. A protection target of the edited confidential file F4 describing the customer information for M4 people is encrypted by using the public key e4. Lengths of the secret keys corresponding to the public keys e1, e2, e3, and e4 are set to d1, d2, d3, and d4 respectively.

As shown in FIG. 5, the customer information management system 50 has a user terminal 60, a customer information management server 70, and the security server 40. As shown in FIG. 6, the user terminal 60 has a user authentication portion 61, a receiving portion 62, an encrypted content decryption portion 63, and a file display portion 64. It is assumed that the user terminal 60 is a low-speed Personal Digital Assistant (PDA). The customer information management server 70 has a user authentication portion 71, a user ID transmission portion 72, a receiving portion 73, a content usable range limitation portion 74, a file decryption portion 75, a file merging portion 76, an encryption key creation portion 77, a file encryption portion 78, and a transmission portion 79. The security server 40 has the user ID receiving portion 41 and the transmission portion 42.

The user authentication portion 71 authenticates a user who accesses the customer information management server 70. The user ID transmission portion 72 transmits a user ID of the authenticated user to the security server 40. The receiving portion 73 receives user qualification information necessary for determining a range usable for the user and security guideline information from the security server 40 by using a communication network such as a LAN. The content usable range limitation portion 74 limits a usable range of contents for the user based on the user qualification information and the number of customer records. The file decryption portion 75 decrypts encrypted confidential files F1, F2, and F3 to a clear text. The file merging portion 76 has a function of merging the confidential files F1, F2, and F3 and a function of preparing the edited confidential file F4. Thereby, by the file merging portion 76, the new edited confidential file F4 including contents of the multiple confidential files F1, F2, and F3 is created based on the multiple confidential files F1, F2, and F3 respectively assigned with individual encryption keys.

The encryption key creation portion 77 creates, as an encryption key for encrypting the edited confidential file F4, secret keys and public keys of RSA cryptosystem being smaller in number than the encryption keys assigned to the multiple confidential files F1, F2, and F3 based on information on the multiple confidential files F1, F2, and F3. Here, the encryption key creation portion 77 creates the encryption key for the edited confidential file F4 based on the information on the multiple confidential files F1, F2, and F3. The file encryption portion 78 encrypts the edited confidential file F4 based on the encryption keys being smaller in number than the encryption keys for encrypting the multiple confidential files F1, F2, and F3. The transmission portion 79 transmits the encrypted edited confidential file F4 and the secret key to the user terminal 60.

The user authentication portion 61 accesses the customer information management server 30 and authenticates the customer information management server 30 that the user is authenticated to view and edit the confidential file F4. The receiving portion 62 receives the encrypted confidential file and the secret key from the customer information management server 70. The encrypted content decryption portion 63 decrypts the encrypted edited confidential file F4 to a clear text. The file display portion 64 displays a user the decrypted edited confidential file F4.

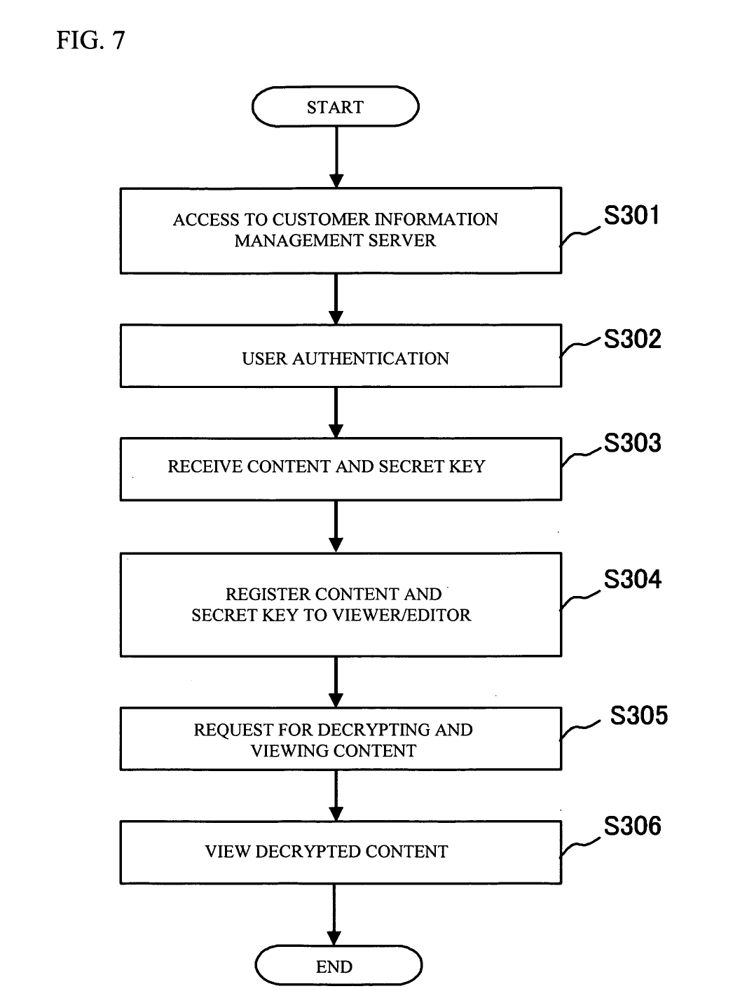

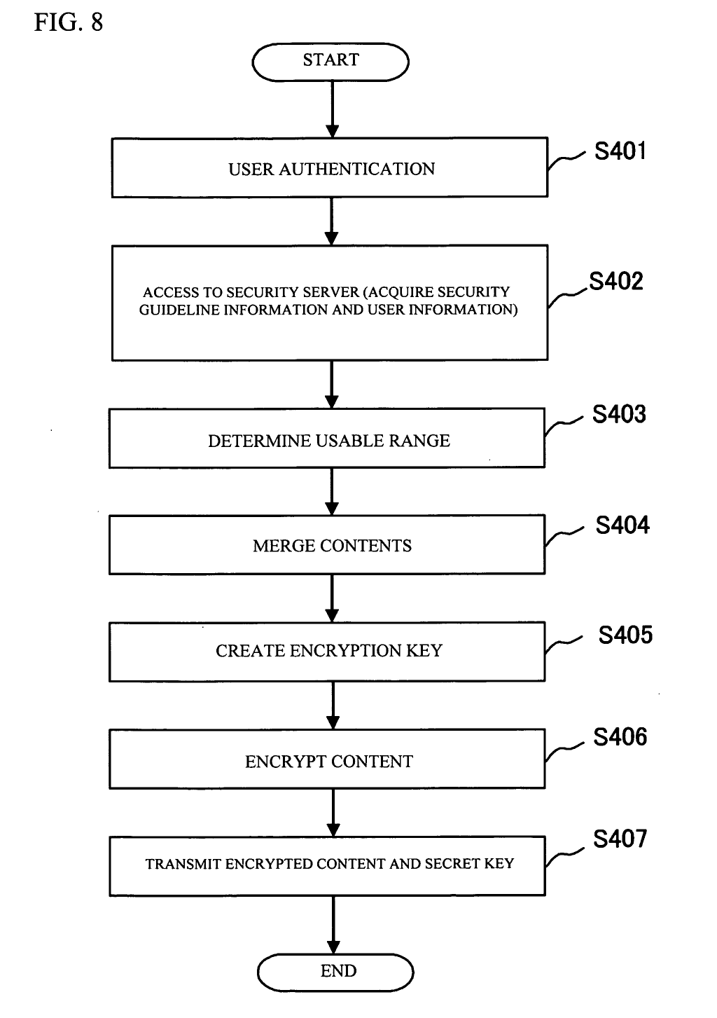

Next, a description will be given of a customer information management system 50 according to the second exemplary embodiment. Procedures' in the second exemplary embodiment are the same as those in the first exemplary embodiment, except for procedures of merging the confidential files F1, F2, and F3, creating the encryption key, and encrypting the edited confidential file F4 by the customer information management server 70, and viewing the encrypted edited confidential file F4 by the user B. Therefore, only these procedures will be described with reference to FIG. 7 and FIG. 8. FIG. 7 is a flowchart showing a procedure which should be conducted by a user who uses contents in the second exemplary embodiment. FIG. 8 shows a procedure conducted by the customer information management server 70 which encrypts a confidential file and transmits the encrypted the confidential file and a secret key to the user according to the second exemplary embodiment.

The user authentication portion 61 of the user terminal 60 accesses the customer information management server 70 (step S301) to perform user authentication (step S302). After user authentication is completed between the user B and the customer information management server 70 (step S401), the user ID transmission portion 72 of the customer information management server 70 accesses the security server 40. The receiving portion 73 acquires user qualification information and security guideline information from the transmission portion 42 of the security server 40 (step S402). Next, the contents usable range limitation portion 74 determines a range of customer information usable for the user B based on the above-described user qualification information (step S403).

The file decryption portion 75 of the customer information management server 70 decrypts protection targets describing customer records which exist in the confidential files F1, F2, and F3 by using the secret keys d1, d2, and d3. The file merging portion 76 merges the confidential files F1, F2, and F3 based on a user's instruction (step S404) to create the edited confidential file F4. Thereby, by the file merging portion 76, the edited confidential file F4 including contents of the multiple confidential files F1, F2, and F3 is created based on the multiple confidential files F1, F2, and F3 respectively assigned with individual encryption keys.

The encryption key creation portion 77 creates, as an encryption key for encrypting a protection target describing customer records in the edited confidential file F4, secret keys and public keys of RSA encryption being smaller in number than the encryption keys for encrypting the multiple confidential files F1, F2, and F3. Here, the encryption key creation portion 77 creates the encryption key for the edited confidential file F4 based on information on the multiple confidential files F1 through F3 (step S405). The encryption key creation portion 77 calculates a value of the edited confidential file F4 for the number of customers M4 based on information on a value per a piece of customer information specified by the security guideline acquired from the security server 40, and determines a key length corresponding to the calculated value of the edited confidential file F4.

Specifically, in the security guideline information acquired from the security server 40, the estimated value F of a calculation amount purchasable at 1 yen, the information on a value V per a piece of customer information, and the protection years Y are described. The encryption key creation portion 77 determines the value T of the edited confidential file F4 describing the customer records for the number of customers M4 by using Expression 1 described in the first exemplary embodiment. Further, the encryption key creation portion 77 calculates the length of the secret key d4, by using the value T of the above-described edited confidential file F4 according to Expression 2 described in the first exemplary embodiment.

Further, the encryption key creation portion 77 creates 160-bit random numbers, which is to be an encryption key of common key encryption used for encrypting the protection target. The file encryption portion 78 encrypts the protection target in the edited confidential file F4 by using the encryption key (step S406). Further, the file encryption portion 78 encrypts the common key by using the foregoing public key e4 of RSA cryptosystem, and attaches the encrypted common key to the encrypted edited confidential file F4. The transmission portion 79 transmits the edited confidential file F4 and the foregoing secret key to the user B by the method to be described later in detail (step S407).

Next, after user authentication, the receiving portion 62 of the user terminal 60 acquires the encrypted edited confidential file F4, the secret key corresponding thereto, and the security guideline information from the customer management information server 70 (step S303). Next, to view the encrypted edited confidential file F4 by using a viewer protected by a tamper resistant function, the acquired secret key and the edited confidential file F4 are registered in the viewer (step S304). The registration is automatically performed by a program retained in the tamper resistant region in the user terminal 60 owned by the user B.

The communication with the customer information management server 70 for downloading is performed on condition that a safe communication path such as a VPN is established. Thus, confidential information such as the secret key shall not be leaked to the user or third parties. Further, the decrypted edited confidential file F4 and the secret key and the common key to be used for encrypting the edited confidential file F4 are always protected by the above-described tamper resistant function for software. As a result, this prevents the user and third parties from getting such information from the device. The encrypted content decryption portion 63 decrypts the encrypted common key attached to the encrypted edited confidential file F4 by using the above-described registered secret key. Further, the encrypted content decryption portion 63 decrypts the encrypted edited confidential file F4 by using the decrypted common key. The file display portion 64 displays the user the decrypted edited confidential file F4 (steps S305 and S306). All the processing is performed while all the confidential information is retained in the tamper resistant region owned by the viewer/editor with the tamper resistant function.

The above-mentioned user terminals 20 and 60, the customer information management servers 30 and 70, and the security server 40 are realized by using, for example, a Central Processing Unit (CPU), a Read Only Memory (ROM), a Random Access Memory (RAM), a hard disk apparatus and the like. The data protection method in accordance with an aspect of the invention is realized by the customer information management systems 10 and 50. Further, the data protection method in accordance with an aspect of the invention can be realized as a program which controls and executes a computer. Such a program can be stored in a magnetic disk, an optical disk, a semiconductor memory or other recording medium and distributed. Otherwise, such a program can be distributed via a network.

The exemplary embodiments of the invention have been described in detail. However, the invention is not limited to such specific exemplary embodiments. Various modifications and alterations can be made within the scope of the invention described in the claims. In the foregoing exemplary embodiments, the description has been given by taking the file describing a customer record as an example of contents. However, the invention is not limited thereto. Further, in the exemplary embodiments, the description has been given by taking the customer record as an example. However, the invention is not limited to the customer record, but includes any record. Further, in the foregoing exemplary embodiments, the description has been given by taking the contents data as an example of data. However, data is not limited to the contents data. Further, while the user terminal 20, the customer information management server 30, and the security server 40 are realized by separate computers, the invention is not limited thereto. The user terminal 20 may be a usual personal computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data protection apparatus comprising:
a determination portion that determines an encryption key used for encrypting edited data in consideration of a total value of each piece of data of one or more pieces of data, when the edited data that includes the one or more pieces of data is created on the basis of the one or more pieces of data; and
an encryption portion that encrypts the edited data on the basis of the encryption key determined by the determination portion.

2. The data protection apparatus according to claim 1, wherein the determination portion determines a key length of the encryption key so that an estimated value of a cost necessary for cracking the encrypted data becomes equal to or more than the total value of the one or more pieces of data.

3. The data protection apparatus according to claim 1, wherein when the one or more pieces of data are assigned with the encryption key that are different from each other, the determination portion uses the encryption key being smaller in number than the encryption keys assigned to the one or more pieces of data, as the encryption key.

4. The data protection apparatus according to claim 1, wherein when the one or more pieces of data include one or more records, the determination portion calculates the value of the edited data by using at least an estimated value per one piece of the records and the number of the records, and determines a key length of the encryption key on the basis of the value of the edited data.

5. The data protection apparatus according to claim 4, wherein the estimated value per one piece of the records is acquired from at least one of a security policy and a security guideline.

6. The data protection apparatus according to claim 4, wherein the record is a customer record.

7. The data protection apparatus according to claim 1, wherein when the one or more pieces of data include customer information, the determination portion calculates the value of the edited data by multiplying the value of information per one piece of the customer information by the number of customers, and determines a key length of the encryption key on the basis of the value of the edited data.

8. The data protection apparatus according to claim 1, wherein when the one or more pieces of data include customer information, the determination portion calculates the value of the edited data by adding a reduction of a brand value associated with discredit caused by customer information leakage to a result obtained by multiplying the value of information per one piece of the customer information by the number of customers, and determines a key length of the encryption key on the basis of the value of the edited data.

9. The data protection apparatus according to claim 1, wherein the determination portion determines protection intensity applied to the edited data depending on at least one of a protection period of the edited data, distribution path information of the edited data, information on a device that uses the edited data, and user profile information on a user who uses the edited data.

10. The data protection apparatus according to claim 1, wherein the determination portion designates protection intensity applied to the edited data by using a length of the encryption key.

11. The data protection apparatus according to claim 1 further comprising a limitation portion that limits a usable range of the one or more pieces of data on the basis of information of a user who uses the one or more pieces of data.

12. The data protection apparatus according to claim 11, wherein when the one or more pieces of data include records, the limitation portion limits the usable range of the one or more pieces of data by using the number of the records.

13. The data protection apparatus according to claim 1, wherein as a method that realizes protection of the edited data, an electronic ticket method is employed.

14. The data protection apparatus according to claim 1, wherein at least one of an electronic certificate, a smart card, and an IC card is used for proving qualification of using the one or more pieces of data.

15. The data protection apparatus according to claim 1, wherein the edited data is a content, and the one or more pieces of data are protection targets in the content.

16. A data protection method comprising:
determining an encryption key used for encrypting edited data in consideration of a total value of each piece of data of one or more pieces of data, when the edited data that includes the one or more pieces of data is created on the basis of the one or more pieces of data; and
encrypting the edited data on the basis of the encryption key determined by the determination portion.

17. The data protection method according to claim 16, wherein determining is to determine a key length of the encryption key so that an estimated value of a cost necessary for cracking the encrypted data becomes equal to or more than the total value of the one or more pieces of data.

18. The data protection method according to claim 16, wherein when the one or more pieces of data are assigned with the encryption key that are different from each other, determining uses the encryption key being smaller in number than the encryption keys assigned to the one or more pieces of data, as the encryption key.

19. The data protection method according to claim 16, wherein when the one or more pieces of data include one or more records, determining calculates the value of the edited data by using at least an estimated value per one piece of the records and the number of the records, and determines a key length of the encryption key on the basis of the value of the edited data.

20. The data protection method according to claim 16, wherein when the one or more pieces of data include customer information, determining calculates the value of the edited data by multiplying the value of information per one piece of the customer information by the number of customers, and determines a key length of the encryption key on the basis of the value of the edited data.

21. The data protection method according to claim 16, wherein when the one or more pieces of data include customer information, determining calculates the value of the edited data by adding a reduction of a brand value associated with discredit caused by customer information leakage to a result obtained by multiplying the value of information per one piece of the customer information by the number of customers, and determines a key length of the encryption key on the basis of the value of the edited data.

22. A computer readable medium storing a program causing a computer to execute a process for data protection, the process comprising:
determining an encryption key used for encrypting edited data in consideration of a total value of each piece of data of one or more pieces of data, when the edited data that includes the one or more pieces of data is created on the basis of the one or more pieces of data; and
encrypting the edited data on the basis of the encryption key determined by the determination portion.
